(19) United States
(12) Patent Application Publication
(10) Pub. No.: US 2026/0169830 A1
(43) Pub. Date: Jun. 18, 2026

(54) SIMULTANEOUS ACCESS TO BACKPLANE-CONNECTED DEVICES VIA AN EDGE COMPUTE MODULE

(71) Applicant: Rockwell Automation Technologies, Inc., Mayfield Heights, OH (US)

(72) Inventors: Ivan Venturini, Gemona del Friuli (IT); David A. Karpuszka, Concord, OH (US); Gary D. Dotson, Muskego, WI (US); Maurizio Fumagalli, Meda (IT); Luca Boscolo, Settimo Milanese (IT); Kenneth W. Batcher, Hudson, OH (US)

(21) Appl. No.: 18/978,961

(22) Filed: Dec. 12, 2024

(51) Int. Cl. G06F 9/54; G06F 13/42

(52) U.S. Cl. CPC G06F 9/541; G06F 13/4221; G06F 2213/0026

(57) ABSTRACT

A non-transitory computer-readable medium may include computer-executable instructions that, when executed, cause a processor system to perform operations including receiving an indication of a computing device being accessible to the processor system, such that the processor system is communicatively coupled to the computing device via a data backplane and the indication is received from the computing device. The processor system may also receive a request to perform a plurality of operations, determine a distribution of the plurality of operations between the processor system and the computing device, and instantiate a plurality of application programming interfaces (APIs) to perform the plurality of operations using the processor system and the computing device.

### BACKGROUND

The present disclosure generally relates to configuring compute modules for use in industrial automation systems. More specifically, the present disclosure relates to systems and methods for employing design software to define properties of a compute module for use in industrial automation systems.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### BRIEF DESCRIPTION

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

A non-transitory computer-readable medium may include computer-executable instructions that, when executed, cause a processor system to perform operations including receiving an indication of a computing device being accessible to the processor system, such that the processor system is communicatively coupled to the computing device via a data backplane and the indication is received from the computing device. The processor system may also receive a request to perform a plurality of operations, determine a distribution of the plurality of operations between the processor system and the computing device, and instantiate a plurality of application programming interfaces (APIs) to perform the plurality of operations using the processor system and the computing device.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 illustrates an example industrial automation system employed by a food manufacturer, in accordance with an embodiment;

FIG. 2 illustrates a diagrammatical representation of an exemplary control and monitoring system that may be employed in any suitable industrial automation system, in accordance with an embodiment;

FIG. 3 illustrates example components that may be part of an embedded edge compute (EEC) module of a control system for the industrial automation system, in accordance with an embodiment;

FIG. 4 illustrates an example control system with a number of modules, in accordance with an embodiment;

FIG. 5 is a block diagram representative of the control system of FIG. 4, in accordance with an embodiment;

FIG. 6 is a block diagram representative of multiple control systems of FIG. 4, in accordance with an embodiment; and

FIG. 7 illustrates a flow chart of a method for distributing operations between EEC modules, in accordance with an embodiment.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers'specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

Embodiments of the present disclosure are generally directed towards industrial compute modules that may be communicatively coupled to a data backplane shared by a number of industrial devices that may be part of an industrial control system for industrial automation environments. An embedded edge compute (EEC) module, as described herein, may provide a range of computational functions to serve as an industrial personal computer (PC) physically sitting in a chassis (e.g., DIN rail), while being directly connected to a communication or data backplane. By way of operation, the EEC module may include an operating system (e.g., Windows/Linux) in which users may access, such that they can deploy their own application software on the EEC module.

The application software executed on the EEC module may then directly (e.g., without intervening components) access other components and devices, such as a programmable logic controller (PLC), via the data backplane. By enabling the EEC module to exchange data with other devices and controllers via the data backplane, the communication between the respective devices may be more efficient as compared to routing data via routers, switches, and other communication devices.

In the present embodiments, the operating system of the EEC module may enable the EEC module to interact or communicate directly with additional EEC modules to facilitate multicasting or communicating simultaneously with two or more other devices communicatively coupled to the backplane. In this way, although each individual EEC module may be limited with respect to latency and processing power by the bandwidth of the backplane and the EEC module, the additional EEC module may enable multiple EEC modules to operate on the same data and distribute operational functions to reduce the overhead operations performed by any one EEC module. That is, the additional EEC module may provide for improved load sharing capabilities to distribute processing tasks

To facilitate the efficient coordination of data communication between multiple EEC modules, the EEC modules may be communicatively coupled to each other via a direct communication link (e.g., peripheral component interconnect (PCI), PCI express) that may include a data bus or connection that may allow different EEC modules to physically and communicatively couple to each other. However, in some embodiments, the communication link may include a wireless link, an optical backplane, near field short range communication links, and the like. As such, although the EEC modules may not physically touch each other, they may still directly connect to each other via the backplane or some dedicated link.

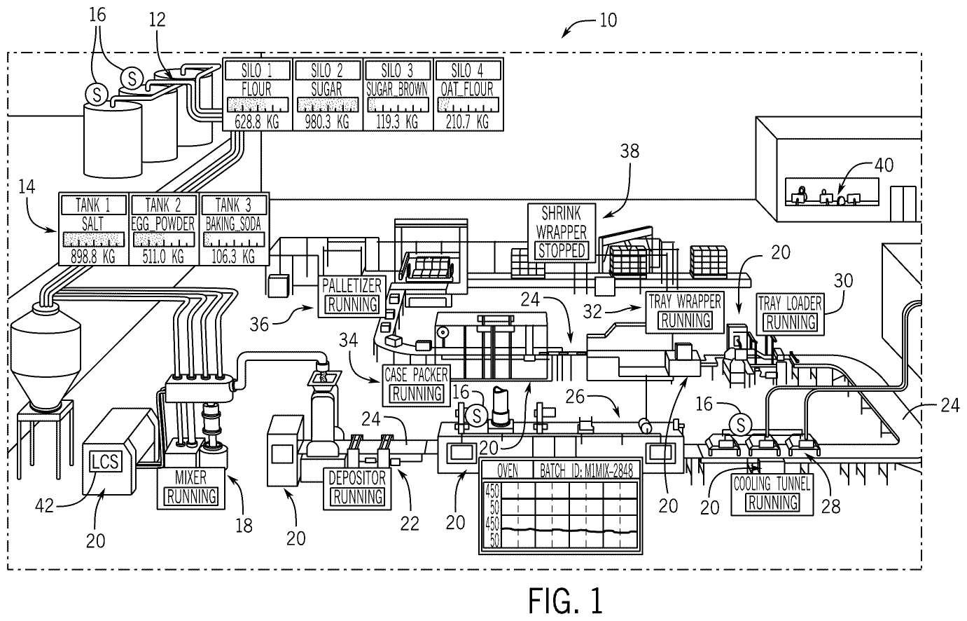

Additionally, when the EEC modules share the same backplane as other devices (e.g., input/output (I/O) devices, programmable logic controllers (PLCs)), the EEC modules may communicate with the other devices in a more efficient manner. Further, each EEC module may execute an application programming interface (API) that enables the respective EEC module to execute multiple sessions or simultaneously execute different applications that don't interact with each other to improve the efficiency of operations performed by the collection of EEC modules. Additional details with regard to coordinating the operations of multiple EEC modules that share the same data backplane is detailed below with reference to FIGS. 1-7.

By way of introduction, FIG. 1 illustrates an example industrial automation system 10 employed by a food manufacturer. It should be noted that although the example industrial automation system 10 of FIG. 1 is directed at a food manufacturer, the present embodiments described herein may be employed within any suitable industry, such as automotive, mining, hydrocarbon production, manufacturing, and the like. The following brief description of the example industrial automation system 10 employed by the food manufacturer is provided herein to help facilitate a more comprehensive understanding of how the embodiments described herein may be applied to industrial devices to significantly improve the operations of the respective industrial automation system. As such, the embodiments described herein should not be limited to be applied to the example depicted in FIG. 1.

Referring now to FIG. 1, the example industrial automation system 10 for a food manufacturer may include silos 12 and tanks 14. The silos 12 and the tanks 14 may store different types of raw material, such as grains, salt, yeast, sweeteners, flavoring agents, coloring agents, vitamins, minerals, and preservatives. In some embodiments, sensors 16 may be positioned within or around the silos 12, the tanks 14, or other suitable locations within the industrial automation system 10 to measure certain properties, such as temperature, mass, volume, pressure, humidity, and the like.

The raw materials may be provided to a mixer 18, which may mix the raw materials together according to a specified ratio. The mixer 18 and other machines in the industrial automation system 10 may employ certain industrial automation devices 20 to control the operations of the mixer 18 and other machines. The industrial automation devices 20 may include controllers, input/output (I/O) modules, display rendering devices (e.g., remote display that renders a graphical user interface (GUI)), a virtual display, motor control centers, motors, human machine interfaces (HMIs), operator interfaces, contactors, starters, sensors 16, actuators, conveyors, drives, relays, protection devices, switchgear, compressors, sensor, actuator, firewall, network switches (e.g., Ethernet switches, modular-managed, fixed-managed, service-router, industrial, unmanaged, etc.) and the like.

The mixer 18 may provide a mixed compound to a depositor 22, which may deposit a certain amount of the mixed compound onto conveyor 24. The depositor 22 may deposit the mixed compound on the conveyor 24 according to a shape and amount that may be specified to a control system for the depositor 22. The conveyor 24 may be any suitable conveyor system that transports items to various types of machinery across the industrial automation system 10. For example, the conveyor 24 may transport deposited material from the depositor 22 to an oven 26, which may bake the deposited material. The baked material may be transported to a cooling tunnel 28 to cool the baked material, such that the cooled material may be transported to a tray loader 30 via the conveyor 24. The tray loader 30 may include machinery that receives a certain amount of the cooled material for packaging. By way of example, the tray loader 30 may receive 25 ounces of the cooled material, which may correspond to an amount of cereal provided in a cereal box.

A tray wrapper 32 may receive a collected amount of cooled material from the tray loader 30 into a bag, which may be sealed. The tray wrapper 32 may receive the collected amount of cooled material in a bag and seal the bag using appropriate machinery. The conveyor 24 may transport the bagged material to case packer 34, which may package the bagged material into a box. The boxes may be transported to a palletizer 36, which may stack a certain number of boxes on a pallet that may be lifted using a forklift or the like. The stacked boxes may then be transported to a shrink wrapper 38, which may wrap the stacked boxes with shrink-wrap to keep the stacked boxes together while on the pallet. The shrink-wrapped boxes may then be transported to storage or the like via a forklift or other suitable transport vehicle.

To perform the operations of each of the devices in the example industrial automation system 10, the industrial automation devices 20 may be used to provide power to the machinery used to perform certain tasks, provide protection to the machinery from electrical surges, prevent injuries from occurring with human operators in the industrial automation system 10, monitor the operations of the respective device, communicate data regarding the respective device to a supervisory control system 40, and the like. In some embodiments, each industrial automation device 20 or a group of industrial automation devices 20 may be controlled using a local control system 42. The local control system 42 may include receive data regarding the operation of the respective industrial automation device 20, other industrial automation devices 20, user inputs, and other suitable inputs to control the operations of the respective industrial automation device(s) 20.

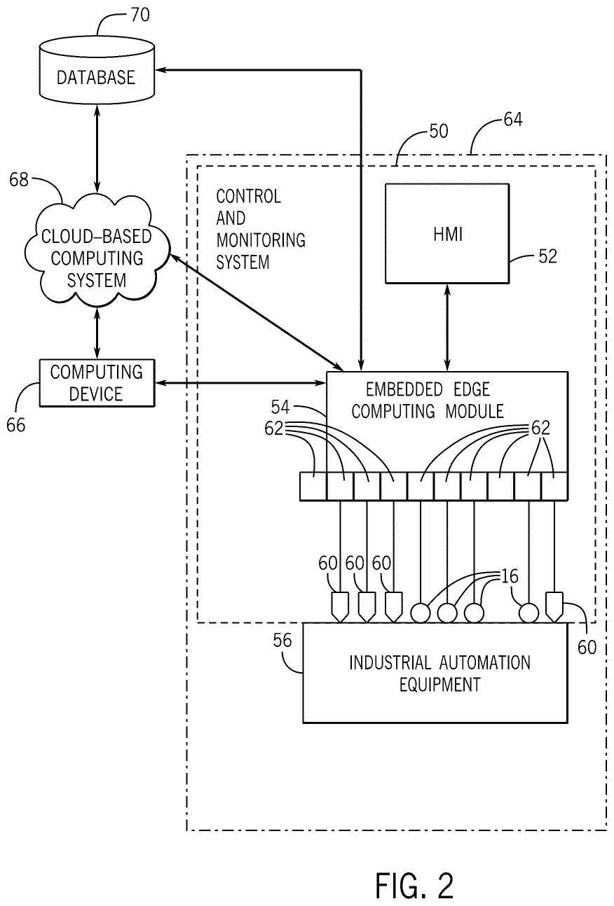

By way of example, FIG. 2 illustrates a diagrammatical representation of an exemplary control and monitoring system 50 that may be employed in any suitable industrial automation system 10, in accordance with embodiments presented herein. In FIG. 2, the control and monitoring system 50 is illustrated as including a human machine interface (HMI) 52 and an embedded edge computing (EEC) module 54 or automation controller adapted to interface with devices that may monitor and control various types of industrial automation equipment 56. By way of example, the industrial automation equipment 56 may include the mixer 18, the depositor 22, the conveyor 24, the oven 26, and the other pieces of machinery described in FIG. 1.

It should be noted that the HMI 52 and the EEC module 54, in accordance with embodiments of the present techniques, may be facilitated by the use of certain network strategies. Indeed, an industry standard network may be employed, such as DeviceNet, to enable data transfer. Such networks permit the exchange of data in accordance with a predefined protocol, and may provide power for operation of networked elements.

As discussed above, the industrial automation equipment 56 may take many forms and include devices for accomplishing many different and varied purposes. For example, the industrial automation equipment 56 may include machinery used to perform various operations in a compressor station, an oil refinery, a batch operation for making food items, a mechanized assembly line, and so forth. Accordingly, the industrial automation equipment 56 may comprise a variety of operational components, such as electric motors, valves, actuators, temperature elements, pressure sensors, or a myriad of machinery or devices used for manufacturing, processing, material handling, and other applications.

Additionally, the industrial automation equipment 56 may include various types of equipment that may be used to perform the various operations that may be part of an industrial application. For instance, the industrial automation equipment 56 may include electrical equipment, hydraulic equipment, compressed air equipment, steam equipment, mechanical tools, protective equipment, refrigeration equipment, power lines, hydraulic lines, steam lines, and the like. Some example types of equipment may include mixers, machine conveyors, tanks, skids, specialized original equipment manufacturer machines, and the like. In addition to the equipment described above, the industrial automation equipment 56 may be made up of certain automation devices 20, which may include controllers, input/output (I/O) modules, motor control centers, motors, human machine interfaces (HMIs), operator interfaces, contactors, starters, sensors 16, actuators, drives, relays, protection devices, switchgear, compressors, firewall, network switches (e.g., Ethernet switches, modular-managed, fixed-managed, service-router, industrial, unmanaged, etc.) and the like.

In certain embodiments, one or more properties of the industrial automation equipment 56 may be monitored and controlled by certain equipment for regulating control variables used to operate the industrial automation equipment 56. For example, the sensors 16 and actuators 60 may monitor various properties of the industrial automation equipment 56 and may adjust operations of the industrial automation equipment 56, respectively.

In some cases, the industrial automation equipment 56 may be associated with devices used by other equipment. For instance, scanners, gauges, valves, flow meters, and the like may be disposed on industrial automation equipment 56. Here, the industrial automation equipment 56 may receive data from the associated devices and use the data to perform their respective operations more efficiently. For example, a controller (e.g., the EEC module 54) of a motor drive may receive data regarding a temperature of a connected motor and may adjust operations of the motor drive based on the data.

In certain embodiments, the industrial automation equipment 56 may include a communication component that enables the industrial equipment 56 to communicate data between each other and other devices. The communication component may include a network interface that may enable the industrial automation equipment 56 to communicate via various protocols such as Ethernet/IP®, ControlNet®, DeviceNet®, or any other industrial communication network protocol. Alternatively, the communication component may enable the industrial automation equipment 56 to communicate via various wired or wireless communication protocols, such as Wi-Fi, mobile telecommunications technology (e.g., 2G, 3G, 4G, 5G, 5GUC, LTE), Bluetooth®, near-field communications technology, and the like.

The sensors 16 may be any number of devices adapted to provide information regarding process conditions. The actuators 60 may include any number of devices adapted to perform a mechanical action in response to a signal from a controller (e.g., the EEC module 54). The sensors 16 and actuators 60 may be utilized to operate the industrial automation equipment 56. Indeed, they may be utilized within process loops that are monitored and controlled by the EEC module 54 and/or the HMI 52. Such a process loop may be activated based on process inputs (e.g., input from a sensor 16) or direct operator input received through the HMI 52. As illustrated, the sensors 16 and actuators 60 are in communication with the EEC module 54. Further, the sensors 16 and actuators 60 may be assigned a particular address via the EEC module 54.

Input/output (I/O) modules 62 may be added or removed from the control and monitoring system 50 via expansion slots, bays, or other suitable mechanisms. In certain embodiments, the I/O modules 62 may be included to add functionality to the EEC module 54, or to accommodate additional process features. For instance, the I/O modules 62 may include circuitry to communicate with new sensors 16 or actuators 60 added to monitor and control the industrial automation equipment 56. It should be noted that the I/O modules 62 may communicate directly to sensors 16 or actuators 60 through hardwired connections or may communicate through wired or wireless sensor networks, such as Hart or IOLink.

Generally, the I/O modules 62 serve as an electrical interface to the EEC module 54 and may be located proximate to the EEC module 54. In such embodiments, data may be communicated with remote modules over a common communication link, or network, wherein modules on the network communicate via a standard communications protocol. Many industrial controllers can communicate via network technologies such as Ethernet (e.g., IEEE802.3, TCP/IP, UDP, Ethernet/IP, and so forth), ControlNet, DeviceNet or other network protocols (Foundation Fieldbus (H1 and Fast Ethernet) Modbus TCP, Profibus) and also communicate to higher level computing systems.

In the illustrated embodiment, several of the I/O modules 62 may transfer input and output signals between the EEC module 54 and the industrial automation equipment 56. As illustrated, the sensors 16 and actuators 60 may communicate with the EEC module 54 via one or more of the I/O modules 62 coupled to the EEC module 54.

In certain embodiments, the EEC module 54 (e.g., the HMI 52, the EEC module 54, the sensors 16, the actuators 60, the I/O modules 62) and the industrial automation equipment 56 may make up an industrial automation application 64. The industrial automation application 64 may involve any type of industrial process or system used to manufacture, produce, process, or package various types of items. For example, the industrial applications 64 may include industries such as material handling, packaging industries, manufacturing, processing, batch processing, the example industrial automation system 10 of FIG. 1, and the like.

In certain embodiments, the EEC module 54 may be communicatively coupled to a computing device 66 and a cloud-based computing system 68. In this network, input and output signals generated from the EEC module 54 may be communicated between the computing device 66 and the cloud-based computing system 68. Although the EEC module 54 may be capable of communicating with the computing device 66 and the cloud-based computing system 68, as mentioned above, in certain embodiments, the EEC module 54 (e.g., local control system 42) may perform certain operations and analysis without sending data to the computing device 66 or the cloud-based computing system 68.

In some embodiments, the cloud-based computing system 68 be communicatively coupled to one or more databases 70. The databases 70 may serve as an application or data repository that may store applications that may be executed by the computing device 66, the EEC module 54, or the like. As such, in one example, the cloud-based computing system 68 or the computing device 66 may coordinate the deployment of certain applications to the EEC module 54, such that the EEC module 54 may execute the applications, which may benefit from direct access to the devices coupled to the device backplane.

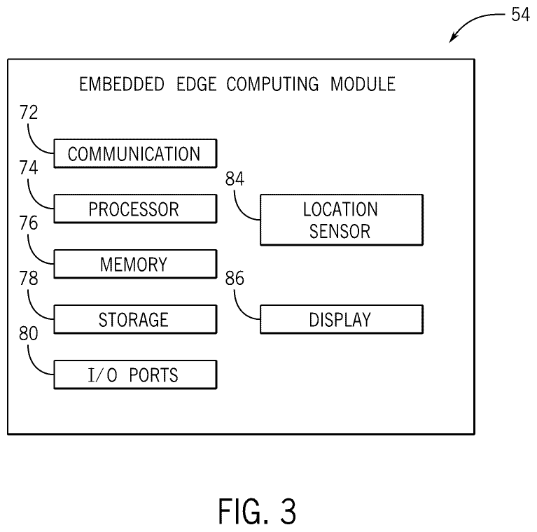

In any case, FIG. 3 illustrates example components that may be part of the EEC module 54, in accordance with embodiments presented herein. For example, the EEC module 54 may include a communication component 72, a processor 74, a memory 76, a storage 78, input/output (I/O) ports 80, a location sensor 84, a display 86, additional sensors (e.g., vibration sensors, temperature sensors), and the like. The communication component 72 may be a wireless or wired communication component that may facilitate communication between the industrial automation equipment 56, the cloud-based computing system 68, and other communication capable devices.

The processor 74 may be any type of computer processor or microprocessor capable of executing computer-executable code. The processor 74 may also include multiple processors that may perform the operations described below. The memory 76 and the storage 78 may be any suitable articles of manufacture that can serve as media to store processor-executable code, data, or the like. These articles of manufacture may represent computer-readable media (e.g., any suitable form of memory or storage) that may store the processor-executable code used by the processor 74 to perform the presently disclosed techniques. Generally, the processor 74 may execute software applications that include programs that enable a user to track and/or monitor operations of the industrial automation equipment 56 via a local or remote communication link. That is, the software applications may communicate with the EEC module 54 and gather information associated with the industrial automation equipment 56 as determined by the EEC module 54, via the sensors 16 disposed on the industrial automation equipment 56 and the like.

The memory 76 and the storage 78 may also be used to store the data, analysis of the data, the software applications, and the like. The memory 76 and the storage 78 may represent non-transitory computer-readable media (e.g., any suitable form of memory or storage) that may store the processor-executable code used by the processor 74 to perform various techniques described herein. It should be noted that non-transitory merely indicates that the media is tangible and not a signal.

In one embodiment, the memory 76 and/or storage 78 may include a software application that may be executed by the processor 74 and may be used to monitor, control, access, or view one of the industrial automation equipment 56. As such, the computing device 66 may communicatively couple to industrial automation equipment 56 or to a respective computing device of the industrial automation equipment 56 via a direct connection between the devices or via the cloud-based computing system 58. The software application may perform various functionalities, such as track statistics of the industrial automation equipment 56, store reasons for placing the industrial automation equipment 56 offline, determine reasons for placing the industrial automation equipment 56 offline, secure industrial automation equipment 56 that is offline, deny access to place an offline industrial automation equipment 56 back online until certain conditions are met, and so forth.

The I/O ports 80 may be interfaces that may couple to other peripheral components such as input devices (e.g., keyboard, mouse), sensors, input/output (I/O) modules, and the like. I/O modules may enable the computing device 66 or other EEC modules 54 to communicate with the industrial automation equipment 56 or other devices in the industrial automation system via the I/O modules.

The location sensor 84 may include circuitry designed to determine a physical location of the computing device 66. In one embodiment, the location sensor 84 may include a global positioning system (GPS) sensor that acquires GPS coordinates for the EEC module 54.

The display 86 may depict visualizations associated with software or executable code being processed by the processor 74. In one embodiment, the display 86 may be a touch display capable of receiving inputs (e.g., parameter data for operating the industrial automation equipment 56) from a user of the EEC module 54. As such, the display 86 may serve as a user interface to communicate with the industrial automation equipment 56. The display 86 may be used to display a graphical user interface (GUI) for operating the industrial automation equipment 56, for tracking the maintenance of the industrial automation equipment 56, and the like. The display 86 may be any suitable type of display, such as a liquid crystal display (LCD), plasma display, or an organic light emitting diode (OLED) display, for example. Additionally, in one embodiment, the display 86 may be provided in conjunction with a touch-sensitive mechanism (e.g., a touch screen) that may function as part of a control interface for the industrial automation equipment 56 or for a number of pieces of industrial automation equipment in the industrial automation application 64, to control the general operations of the industrial automation application 64. In some embodiments, the operator interface may be characterized as the HMI 52, a human-interface machine, or the like.

Although the components described above have been discussed with regard to the EEC module 54, it should be noted that similar components may make up other computing devices described herein. Further, it should be noted that the listed components are provided as example components and the embodiments described herein are not to be limited to the components described with reference to FIG. 3.

Referring back to FIG. 2, in operation, the industrial automation application 64 may receive one or more inputs used to produce one or more outputs. For example, the inputs may include feedstock, electrical energy, fuel, parts, assemblies, sub-assemblies, operational parameters (e.g., sensor measurements), or any combination thereof. Additionally, the outputs may include finished products, semi-finished products, assemblies, manufacturing products, by products, or any combination thereof.

To produce the one or more outputs, the EEC module 54 may control operation of the industrial automation application 64. In some embodiments, the EEC module 54 may control operation by outputting control signals to instruct industrial automation equipment 56 to perform a control action by implementing manipulated variable set points. For example, the EEC module 54 may instruct a motor (e.g., an automation device 20) to implement a control action by actuating at a particular speed (e.g., a manipulated variable set point).

In some embodiments, the EEC module 54 may determine the manipulated variable set points based at least in part on process data. As described above, the process data may be indicative of operation of the industrial automation device 20, the industrial automation equipment 56, the industrial automation application 64, and the like. As such, the process data may include operational parameters of the industrial automation device 20 and/or operational parameters of the industrial automation application 65. For example, the operational parameters may include any suitable type, such as temperature, flow rate, electrical power, and the like.

Thus, the EEC module 54 may receive process data from one or more of the industrial automation devices 20, the sensors 16, or the like. In some embodiments, the sensor 16 may determine an operational parameter and communicate a measurement signal indicating the operational parameter to the EEC module 54. For example, a temperature sensor may measure temperature of a motor (e.g., an automation device 20) and transmit a measurement signal indicating the measured temperature to the EEC module 54. The EEC module 54 may then analyze the process data to monitor performance of the industrial automation application 64 (e.g., determine an expected operational state) and/or perform diagnostics on the industrial automation application 64.

In some embodiments, the supervisory control system 40 may provide centralized control over operation of the industrial automation application 64. For example, the supervisory control system 40 may enable centralized communication with a user (e.g., operator). To facilitate, the supervisory control system 40 may include the display 86 to facilitate providing information to the user. For example, the display 86 may display visual representations of information, such as process data, selected features, expected operational parameters, and/or relationships there between. Additionally, the supervisory control system 40 may include similar components as the EEC module 54 described above in FIG. 3.

On the other hand, the EEC module 54 may provide localized control over a portion of the industrial automation application 64 via the local control system 42. For example, in the depicted embodiment of FIG. 1, the local control system 42 that may be part of the mixer 18 may provide control over operation of a first automation device 20 that controls the mixer 18, and a local control system 42 may provide control over operation of a second automation device 20 that controls the operation of the depositor 22.

In some embodiments, the local control system 42 may control operation of a portion of the industrial automation application 64 based at least in part on the control strategy determined by the supervisory control system 40. Additionally, the supervisory control system 40 may determine the control strategy based at least in part on process data determined by the local control system 42. Thus, to implement the control strategy, the supervisory control system 40 and the local control systems 42 may be communicatively coupled via a network, which may be any suitable type, such as an Ethernet/IP network, a ControlNet network, a DeviceNet network, a Data Highway Plus network, a Remote I/O network, a Foundation Fieldbus network, a Serial, DH-485 network, a SynchLink network, or any combination thereof.

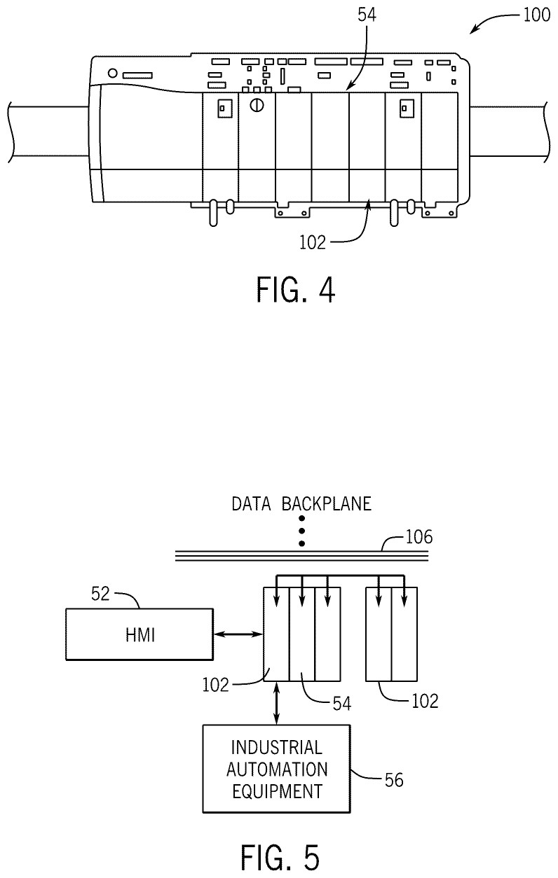

It should be appreciated that the described embodiment of the local control system 42 is merely intended to be illustrative and not limiting. The local control system 42 may include one or more components of the EEC module 54. In some cases, the EEC module 54 may be one component of the local control system 42. That is, the EEC module 54 may be part of a collection of modules, such as a control system 100 (e.g., local control system 42) depicted in FIG. 4.

As shown in FIG. 4, the control system 100 may include the EEC module 54 as a single module of a number of modules that perform various types of operations. For instance, the control system 100 may also include an input/output (I/O) module 102 and the EEC module 54. The control system 100 may be coupled to a data backplane 106 that may facilitate communication between modules of the control system 100.

For example, FIG. 5 illustrates a block diagram of the control system 100 that may include the EEC module 54 and the I/O module 102 coupled to each other via the data backplane 106. The data backplane 106 is provided over which multiple automation components may communicate. As will be appreciated by those skilled in the art, such backplanes may allow for physical mounting of modular devices, such as automation controllers, input/output devices, and so forth. Data communication over the backplane 106 may allow for raw, process, or other data to be accessed by the EEC module 54 via other modules of the control system 100, the I/O module 102, or the like. Data may also be output from the control system 100 via the data backplane 106. For instance, the I/O module 104 may output visualization data to the EEC module 54, which may present the visualization data via an electronic display.

With the foregoing in mind, the EEC module 54 may provide in-chassis, high-speed computing functionality that may communicate directly with other modules coupled to the backplane 106. The EEC module 54 may provide the flexibility to be programmed with custom applications while employing any suitable operating system (e.g., Windows, Linux). By incorporating the EEC module 54 into the data backplane 106, the EEC module 54 may provide a compute product within a closer proximity to sources of data (e.g., via other modules on the data backplane 106). In addition, the EEC module 54 may include a display communication port (e.g., DisplayPort) to provide visualizations to connected displays, the HMI 52, or the like.

By way of configuration, the EEC module 54 may include software or firmware stored therein that provides information to design software that may be executed on a separate computing device (e.g., computing device 66). That is, the EEC module 54 may broadcast the information identifying the EEC module 54, such that the computing device 66 or the design software executed by the computing device 66 may detect the presence of the EEC module 54.

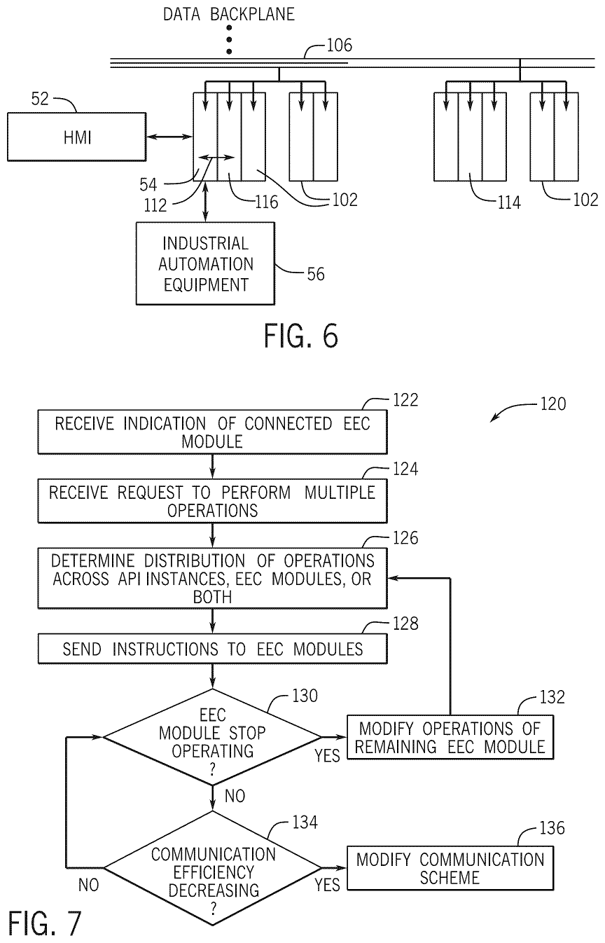

Keeping this in mind, FIG. 6 illustrates a block diagram of the control system 100 that may include multiple EEC modules 54 and the I/O module 102 coupled to each other via the data backplane 106. The data backplane 106 is provided over which the multiple EEC modules 54 may communicate with different I/O modules 102, industrial automation equipment 56, and the like.

In some embodiments, multiple EEC modules 54 sharing the same data backplane 106 may result in reduced network bandwidth and latency efficiency in communication, as each EEC module 54 perform their respective functions. That is, by sharing the same data backplane 106, the operations of one EEC module 54 performing operations that includes retrieving data from a controller, while another EEC module 54 access the same data backplane 106 less frequency, may result in reduced communication efficiency. As such, in some embodiments, a communication link 112 may exist between adjacent EEC modules 54 (e.g., with EEC module 116) to enable the EEC modules 54 to communicate with each other while bypassing the data backplane 106.

The communication link 112 may include a high-speed serial communication bus, such as a Peripheral Component Interconnect Express (PCIe) bus or the like. In some embodiments, the EEC modules 54 may include a port on each side to facilitate a physical connection to each other, thereby establishing a high-speed communication bus connection between the two EEC modules 54. Indeed, one port of the EEC module 54 may include female port that may interconnect with a male port positioned on the opposite side of the EEC module 116. In any case, by including the communication link 112 between the two EEC modules 54/116 in addition to the connection via the data backplane 106, the two EEC modules 54/116 may coordinate communication operations to improve network bandwidth and latency of the data backplane 106. That is, the communication link 112 provides a side channel that allows the EEC module to avoid the data backplane 106, and, instead, employ a virtual bus that exists between the two EEC modules 54/116. Indeed, in some embodiments, a real-time processor or control logic may manage the communications between the two EEC modules 54, other I/O devices 102, devices coupled to the data backplane 106, and the like. In some embodiments, an Application Programming Interface (API) may be implemented as software to manage the communication sessions executed by the EEC module 54.

With the foregoing in mind, the EEC module 54 may execute an API that provides a set of rules, communication protocols, and tools for the EEC module 54 to communicate with multiple devices via the communication link 112, other devices via the data backplane 106, and the like. In some embodiments, the API may be executed by the processor 74 based on instructions or software stored in the memory 76, the storage 78, and the like.

By way of operation, the EEC module 54 may execute multiple API instances in parallel to handle large volumes of requests or more than a threshold of communications from the connected devices. In some embodiments, control logic of the EEC module 54 may scale the APIs being executed based on a current number of received requests or a current communication bandwidth. That is, the EEC module 54 may increase the number of API instances being executed in response to the number of received requests increasing, the amount of available communication bandwidth increasing, and the like.

In some embodiments, the EEC module 54 may manage Class 1 and Class 3 connections in the industrial network. That is, Class 1 connections may include real-time control and time-critical communications that operate on lower latencies for high priority control. Class 3 communications, on the other hand, may include non-real-time communication, such as data monitoring. With this in mind, the EEC module 54 may deploy API instances to manage the Class 1 or Class 3 communications. For instance, one API instance may be deployed to manage the Class 1 communications, while the EEC module 54 may maintain a queue of Class 3 communications to facilitate at a later time via a separate API instances after the Class 1 communications are facilitated.

In addition to executing multiple API instances on a single EEC module 54, EEC modules 54 may operate as a gateway for other EEC modules 54 to access devices connected to the respective EEC module 54. For instance, the EEC module 54 may operate as a client programmable logic controller (PLC) for the industrial automation equipment 56, while also serving as a gateway for accessing the industrial automation equipment by a separate EEC module 114. Indeed, in some embodiments, the PLC may be implemented via the I/O module 102 communicatively coupled to one of the EEC modules 54 sharing the same data backplane 106 as the I/O module 102.

By way of example, an application being executed on the EEC module 114 may be requesting a variable from a PLC of the industrial automation equipment 56 that shares the data backplane with the EEC module 54. As such, the EEC module 114 may send a request for the data to the EEC module 54, which may be executing multiple API instances. One of the API instances may retrieve data at regular intervals from the PLC (e.g., I/O module 102), while a second API instance may facilitate communications with the EEC module 114. In this case, the control logic of the EEC module 54 may coordinate the collection of the requested data and the transmission of the requested data to the EEC module 114 by managing the operations of the two API instances. In this way, a single EEC module 54 may be capable of communicating with multiple devices, as opposed to being capable of maintaining a one-to-one communication channel.

To facilitate communications between the EEC module 54, the EEC module 114, the EEC module 116, and the like, different networking technologies may be used. For instance, the EEC module 114 may bridge a connection to the EEC module 54 using a Device Level Ring (DLR) protocol, parallel redundancy protocol (PRP), or the like. The DLR protocol may enable the EEC module 54 to access the I/O modules 102 and the EEC module 114 via an interconnected ring configuration that ensure high availability and fault tolerance by having redundant communication paths through either direction of the ring. In addition, the API instance coordinating networking operations may accommodate address-based communication to route messages and requests to different devices based on the respective address. In this way, the API may allow for directionality and addressing parameters to be used in routing communications.

In some embodiments, the control logic of the EEC module 54/116 may also coordinate communications to efficiently send data between EEC modules 54/116 via the data backplane 106 or the communication link 112. That is, the communication link 112 may provide the most efficient (e.g., time) manner to communicate data between the EEC modules 54/116. However, if the EEC modules 54/116 share a memory component or resources (e.g., via the I/O module 102), the control logic may coordinate communications via the data backplane 102 to efficiently access data that may be accessible via the data backplane 106. That is, the control logic may manage the communication between the two EEC modules 54/116 to enable the data to be communicated in the most efficient manner based on the available bandwidth of the data backplane 106, the shared resources of the communicating devices, and the like.

With this in mind, the EEC module 54 may include a field-programmable gate array (FPGA) circuit with a direct memory access (DMA) engine that the EEC module 54 may use to accelerate data traffic in accordance with certain rules. For instance, data flow running on the EEC module 54 may be obtained, analyzed, and optimized with respect to moving or collecting data and tags between the EEC module 54 and a host processor of the industrial equipment 56 or the like. If the EEC module 54 uses peer-to-peer mode communication, the access to the I/O module 102 may be improved by avoiding communicating with an associated controller, but instead communicating to another EEC module 116 or directly to an I/O module 102.

In addition to operating as a gateway device, multiple EEC modules 54/116 may perform redundant operations to allow one EEC module to take over for another EEC module for a given circumstance. For instance, the EEC module 54 and the EEC module 116 may both execute the same API instances that collect the same datasets from the industrial automation equipment 56. In some embodiments, the EEC module 54 may maintain the communication with the cloud-based computing system 68, the computing device 66, or the like to send the collected data. The EEC module 116, on the other hand, may just collect the data without forwarding the collected data to the other devices. In some embodiments, a light heartbeat message (e.g., and acknowledgement) may be sent between the EEC module 54 and the EEC module 116 (e.g., via the communication link 112) to confirm that each EEC module 54/116 is operating. If one of the EEC modules 54/116 does not receive a response or acknowledgement, the transmitting EEC module 54/116 may assume primary communication responsibilities and establish a communication link with the external device to provide requested datasets.

Keeping this in mind, FIG. 7 illustrates a flow chart of a method 120 for coordinating communication operations via the EEC module 54, in accordance with embodiments presented herein. Although the following description of the method 120 is described as being performed by EEC module 54 and in particular order, it should be understood that the method 120 may be performed by any suitable computing device and in any suitable order.

Referring now to FIG. 6, at block 122, the EEC module 54 may receive an indication of a connected EEC module 114/116. That is, the EEC module 54 may query or ping the accessible communication channels to detect whether any other EEC modules are connected thereto. In one embodiment, the EEC module 54 may send a secure packet through each available communication channel and may wait to receive a secure response packet from the connected device. As such, after receiving the secure packet, the EEC module 54 may include software that may open or access the contents of the secure packet based on a security certificate stored therein. The security certificate may be pre-stored and configured to enable the EEC module 54 to decrypt or access secure packets sent from a particular manufacturer, vendor, or the like.

In addition, after detecting access to one or more communication channels, the EEC module 54 may request one or more identification packets that include information related to the connected EEC modules. The information may include manufacturer information, firmware version data, model number, serial number, and other properties that may identify the connected EEC modules. In some embodiments, the identification packet may also include a security certificate that may be decrypted by the EEC module 54.

After receiving an indication that the EEC module(s) is connected to the EEC module 54, the EEC module 54 may, at block 124, receive a request to perform multiple operations. That is, the EEC module 54 may receive a user request or a request from a supervisory system to perform certain tasks or operations. The tasks may include collecting data from the industrial automation equipment 56, performing analysis operations on acquired data, communicating data to other devices, and the like.

After receiving the request, the EEC module 54, at block 126, may determine a manner in which to distribute the requested operations across API instances within the respective EEC module 54, across additional EEC modules 114/116, or both. As discussed above, the EEC module 54 may employ multiple instances of an API to perform multiple tasks in parallel. To determine whether the EEC module 54 should implement (e.g., instantiate) multiple API instances, the EEC module 54 may simulate or calculate an expected computational resource parameter (e.g., memory, processing power, processing latency, power) expended to perform the respective tasks. If the expected computational resource parameter exceeds some threshold indicative of the EEC module 54 operating inefficiently, the EEC module 54 may execute one or more additional API instances to perform different tasks. If the additional API instances does not enable the EEC module 54 to use expected computational resource parameters below the threshold, the EEC module 54 may proceed to block 128 and send instructions to one or more other EEC modules 114/116 to perform certain tasks via API instances.

By way of example, the EEC module 54 may identify EEC modules 114/116 based on data sources that may be part of the respective task. That is, if the data source associated with the respective task is located on the same data backplane 106 as the EEC module 54, the EEC module 54 may identify the EEC module 116 that shares the same data backplane 106 as the data source. In this way, the EEC module 54 may identify suitable EEC modules 114/116 to employ based achieving the highest throughput, lowest latency, and the like by employing the API instances, communication link 112, and data backplane 106.

After the EEC module 54 identifies the suitable EEC modules 114/116 to distribute tasks, the EEC module 54, at block 128, may send instructions to the EEC modules 114/116 to perform the respective tasks. After the EEC modules 54/114/116 perform the tasks in response to the received instructions, the EEC module 54 may, at block 130, monitor the operational status of the EEC modules 114/116 to determine if the EEC modules 114/116 stops operating. That is, the EEC module 54 may periodically send a signal to the EEC modules 114/116 to confirm that the EEC modules 114/116 is operating. If the EEC module 54 does not receive an acknowledgement signal or determines that the EEC modules 114/116 is not operating, the EEC module 54 may proceed to block 132 and modify the distributed operations based on the EEC modules 114/116 no longer being operational. As such, the EEC module 54 may determine a more suitable distribution of the operations based on the available EEC modules 114/116.

If, at block 130, the EEC module 54 does not determine that the EEC modules 114/116 stopped operating, the EEC module 54 may proceed to block 134. At block 134, the EEC module 54 may determine if the communication efficiency parameters are decreasing or falling below some threshold. The communication efficiency parameters may include a throughput, network latency, or the like. If the communication efficiency parameters fall below a threshold, the EEC module 54 may modify the communication scheme currently being employed. That is, the EEC module 54 may adjust communication operations to communicate in a more efficient or different manner. For example, the EEC module 54 may communicate certain data types with the EEC module 116 via the communication link 112, while communicating with other devices via the data backplane 106. The modification of the communication scheme may be designed to cause the communication efficiency parameters to return to a desired level or above the respective threshold.

With the foregoing in mind, in some embodiments, multiple EEC modules 54/114/116 may be assigned to one or more groups through the API, a design software tool, or the like. By assigning different EEC modules to the same group, a message transmitted to a particular group via the data backplane 106 may be received by each member of the group. In some embodiments, the groups may be associated with an address (e.g., bit address in data packet) that may operate as a pointer to one or more EEC modules. As such, when a group message is sent to the data backplane 106, an address field of the message may include a value that represents the group and points to each address of the EEC modules that are part of the selected group. As each EEC module receives the message, the EEC module may determine whether the message is directed to a group corresponding to the respective EEC module. In some embodiments, a user can assign an EEC module to a group through a register. And then the Apex ASIC will emit the traffic or shut up accordingly.

The techniques presented and claimed herein are referenced and applied to material objects and concrete examples of a practical nature that demonstrably improve the present technical field and, as such, are not abstract, intangible, or purely theoretical. Further, if any claims appended to the end of this specification contain one or more elements designated as “means for [perform]ing [a function]...” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

While only certain features of the present embodiments described herein have been illustrated and described herein, many modifications and changes will occur to those skilled in the art. It is, therefore, to be understood that the appended claims are intended to cover all such modifications and changes as fall within the true spirit of the disclosure.

1. A non-transitory computer-readable medium comprising computer-executable instructions that, when executed, cause a processor system to perform operations comprising:
receiving an indication of a computing device being accessible to the processor system, wherein the processor system is communicatively coupled to the computing device via a data backplane, and wherein the indication is received from the computing device;
receiving a request to perform a plurality of operations via the processor system;
determining a distribution of the plurality of operations between the processor system and the computing device; and
instantiating a plurality of application programming interfaces (APIs) to perform the plurality of operations using the processor system and the computing device.

2. The non-transitory computer-readable medium of claim 1, wherein the processor system is configured to determine the distribution of the plurality of operations based on throughput, latency, or both.

3. The non-transitory computer-readable medium of claim 1, wherein the computer-executable instructions that, when executed, cause the processor system to perform the operations further comprising:
monitoring an operational status of the computing device; and
modifying the distribution of the plurality of operations based on the operational status.

4. The non-transitory computer-readable medium of claim 1, wherein the processor system and the computing device is configured to communicate data with each other via a direct data link.

5. The non-transitory computer-readable medium of claim 1, wherein the direct data link comprises a Peripheral Component Interconnect Express (PCI-e) link.

6. The non-transitory computer-readable medium of claim 5, wherein the processor system and the computing device are positioned adjacent to each other.

7. The non-transitory computer-readable medium of claim 1, wherein the computer-executable instructions are configured to cause the processor system to perform the operations further comprising:
determining that one or more communication parameters associated with communication between the processor system and the computing device are below one or more thresholds; and
modifying one or more communications between the processor system and the computing device in response to the one or more communication parameters being below the one or more thresholds.

8. A method, comprising:
receiving, via a processor system, an indication of a computing device being accessible to the processor system, wherein the processor system is communicatively coupled to the computing device via a data backplane, and wherein the indication is received from the computing device;
receiving, via the processor system, a request to perform a plurality of operations via the processor system;
determining, via the processor system, a distribution of the plurality of operations between the processor system and the computing device; and
instantiating, via the processor system, a plurality of application programming interfaces (APIs) to perform the plurality of operations using the processor system and the computing device.

9. The method of claim 8, wherein the processor system is configured to determine the distribution of the plurality of operations based on throughput, latency, or both.

10. The method of claim 8, further comprising:
monitoring an operational status of the computing device; and
modifying the distribution of the plurality of operations based on the operational status.

11. The method of claim 8, wherein the processor system and the computing device is configured to communicate data with each other via a direct data link.

12. The method of claim 11, wherein the direct data link comprises a Peripheral Component Interconnect Express (PCI-e) link.

13. The method of claim 12, wherein the processor system and the computing device are positioned adjacent to each other.

14. The method of claim 8, further comprising:
determining that one or more communication parameters associated with communication between the processor system and the computing device are below one or more thresholds; and
modifying one or more communications between the processor system and the computing device in response to the one or more communication parameters being below the one or more thresholds.

15. A system, comprising:
an industrial device configured to be communicatively coupled to a data backplane;
a processor system configured to communicatively couple to the industrial device via the data backplane, wherein the processor system is configured to execute computer-readable instructions that cause the processor system to execute to perform operations comprising:
receiving an indication of a computing device being accessible to the processor system, wherein the processor system is communicatively coupled to the computing device via a data backplane, and wherein the indication is received from the computing device;
receiving a request to perform a plurality of operations via the processor system;
determining a distribution of the plurality of operations between the processor system and the computing device; and
instantiating a plurality of application programming interfaces (APIs) to perform the plurality of operations using the processor system and the computing device.

16. The system of claim 15, wherein the industrial device comprises one or more controllers, one or more compute modules, one or more input/output (I/O) modules, one or more motor control centers, one or more human machine interfaces (HMIs), one or more operator interfaces, one or more drives, one or more protection devices, or any combination thereof.

17. The system of claim 15, wherein the processor system and the computing device is configured to communicate data with each other via a direct data link.

18. The system of claim 17, wherein the direct data link comprises a Peripheral Component Interconnect Express (PCI-e) link.

19. The system of claim 18, wherein the processor system and the computing device are positioned adjacent to each other.

20. The system of claim 19, wherein the processor system and the computing device are configured to perform the plurality of operations via the data backplane and the PCI-e link.
